(19) United States
(12) Patent Application Publication
(10) Pub. No.: US 2011/0036519 A1
(43) Pub. Date: Feb. 17, 2011

(54) External Tandem Screen Assembly

(76) Inventors: Peter Doogan, Victoria (AU); Gregory Moczynski, Victoria (AU)

Correspondence Address: JOHN ALEXANDER GALBREATH, 2516 CHESTNUT WOODS CT, REISTERSTOWN, MD, 21136, US

(21) Appl. No.: 12/863,445

(22) PCT Filed: Jan. 19, 2009
(86) PCT No.: PCT/AU09/00057

§ 371 Date: Aug. 7, 2010

(30) Foreign Application Priority Data
Jan. 19, 2008 (AU) 2008900242

(51) Int. Cl. E06B 9/08; A47H 1/18

(52) U.S. Cl. 160/368.1; 160/120

(57) ABSTRACT

A tandem screen assembly for shielding an external area of a building such as a colonnade by attaching a head box to the outside of the building and two pairs of upright guides are at each end of the head box which provide a track for a transparent roller screen and a track for a mesh roller screen side by side so that one screen lies in front of the other in a compact arrangement. The assembly is modified by the inclusion of a mullion which creates a passageway into the shielded area. The pairs of upright guides permit the locking of a screen rail at half height. A screen rail has a handle which shoots bolts in and out of the upright guides to arrest the screens, allowing them to be tensioned by the hand crank or electric motor drive.

### FIELD OF THE INVENTION

This invention concerns the provision of screens for the external areas of dwellings and businesses such as outdoor cafes.

### BACKGROUND OF THE INVENTION

Some homes have outdoor entertainment areas which accommodate a table and chairs, speakers for relaying music, fountains and the like. Home owners seek to maximise the use of such areas by excluding breezes and excessive sun by the provision of pull down screens.

If the shielded area is to provide solar reduction while retaining a view then mesh is effective. If overall weatherproofing is desired then transparent plastic is the choice. In sunny latitudes both are needed. Fortunately roller screens in useful variety are available, for example those having an electric motor mounted within the roller of the screen at one end thereof, but although the motor fits inside the roller to give maximum width of screen, to accommodate two rollers placed close together presents installation problems.

Such screens are usually installed by specialist contractors. While it is straightforward to enclose colonnades and porch like additions in a dwelling, the provision of both mesh and plastic screens introduces a problem in that finding room for a duplicate system is insoluble in many buildings.

These are discussed in U.S. Pat. No. 5,392,835. The use of screen mesh requires adequate tensioning conveniently provided by a lead bar with multiple bristles on the bottom edge to contact the window ledge. A large capacity head box houses a roller shutter casing which leaves ample room for a screen mesh roller beneath it. Although the roller shutter is stable the mesh is not when the shutter is up and the mesh is down, breezes are apt to displace the mesh in the lateral guides at the edges of the window. Consequently the lateral guides house a rubber tube which is inflated in order to nip the mesh against the lateral guide.

This arrangement is not intended to be adjustable whereas if the mesh is providing solar control it is desirable that the mesh be stable at any selected height.

### SUMMARY OF THE INVENTION

The first apparatus aspect of the invention provides a tandem screen assembly for shielding an external area of a building comprising a head box for attachment to the outside of the building,

a first rotatable screen mountable in the head box,
a second rotatable screen mountable in front of the first screen,
a pair of upright guides mountable beneath the head box at both ends thereof arranged and aligned to provide a track for the first screen and a track for the second screen side by side.

A second apparatus aspect of the invention provides a tandem screen assembly for shielding an external area of a building comprising a head box for attachment to the outside of the building, a pair of outer upright guides mountable beneath the head box at both ends, two pairs of upright guides placed back to back intermediate the outer guides also beneath the head box thereby defining two side by side areas each protectable by two screens lying one in front of the other.

A third apparatus aspect of the invention provides a component for a tandem screen assembly, namely a head box of a tandem screen assembly for shielding an external area of a building, comprising an L-section back and top for attachment to the outside of a building, a top and two end walls, a third wall intermediate the ends, the end walls each being adapted to mount a pair of rotatable screens and the third wall being adapted to mount the four opposite ends of both pairs of screens.

A fourth apparatus aspect of the invention provides a bottom rail for a tandem screen assembly for shielding an external area of a building, comprising a tube, the ends of which have bolt mounts, bolts which slide in the mounts and project from the ends of the tube, a handle mount located between the ends of the tube, a rotatable handle linked to both bolts for dual operation and a slot for receiving and retaining the free end of the screen.

### BRIEF DESCRIPTION OF THE DRAWINGS

One embodiment of the invention is now described with reference to the accompanying drawings, in which:

FIG. 1 is an elevation of a dwelling with a colonnade above a deck.

FIG. 2 shows the colonnade enclosed by a tandem screen assembly according to the invention.

FIG. 3 is a diagrammatic side sectional view of the assembly showing the working parts.

FIG. 4 shows the interior of FIG. 2.

FIG. 5 is a perspective of the assembly made from a kit.

FIG. 6 is a plan of one of the upright guides.

FIG. 7 is a perspective of the bottom rail which captures the moving end of the screen with the rail body cover removed.

FIG. 8 is a section through the rail.

FIG. 9 is a detailed plan of half of the rail shown in FIG. 8.

### DETAILED DESCRIPTION WITH RESPECT TO THE DRAWINGS

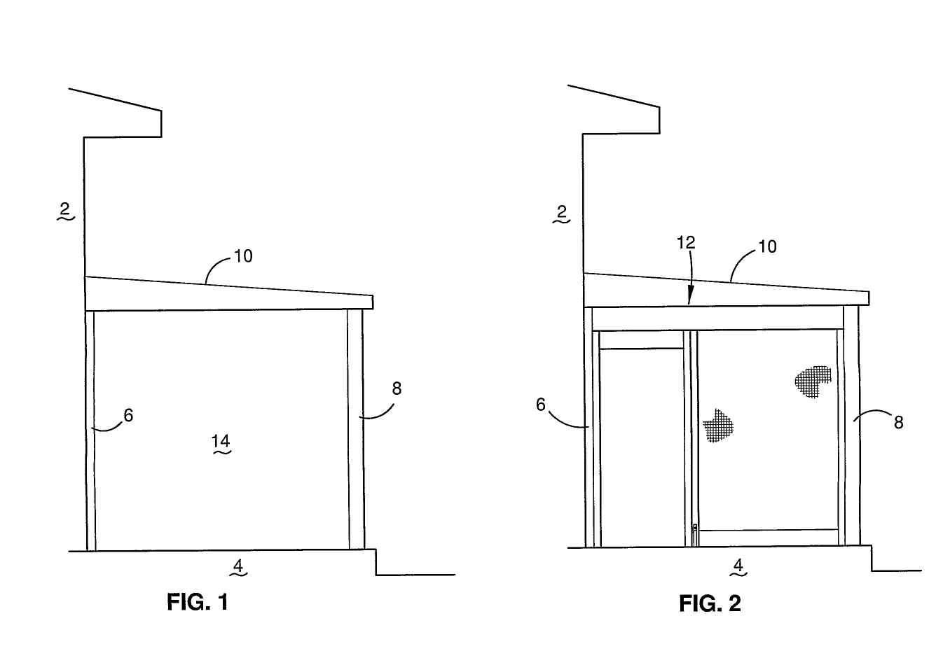

Referring now to the drawings, FIG. 1 depicts the rear of a dwelling 2 BEFORE the screen assembly is fitted. A deck 4 runs along the rear wall. Posts 6 and a colonnade of posts 8 support inclined roof 10. Individual assemblies 12 are installed between successive posts 8 of the colonnade. FIG. 2 shows the change in appearance AFTER the assembly is fitted to the space 14 shown in FIG. 1.

In FIGS. 2-4, the head box 16 extends from post 6 to post 8 and is attached to the header of the colonnade. A vertical twin track guide 18 (100×80 mm) made of extruded aluminium is screwed to post 8. The upper end projects inside the head box. A second like guide 20 is screwed to post 6. The head box is made from a rear L-section extruded aluminium panel 22 and a tilting arcuate front panel 24 which obscures the roller screens 26, 28.

An upright composed of a third and fourth guides 30, 32 are joined back to back so that the tracks of 18 face the tracks of 30 and the tracks of 20 face the tracks of 32. The guides 30, 32 engage the head box and carry a slide bolt 34 which shoots into a socket 36 in the deck. The intermediate upright or mullion divides the space between the guides 18, 20 into a passageway 38 and an adjacent space 40. In a variant all four guides are made from a single extrusion.

The L-section back and top of the head box have extruded screw sites for receiving screws which clamp end walls 42, 44 to the head box. These end walls are bored to receive the shafts of the screens which extend from end wall to end wall. The screens lie one in front of the other so that the transparent pvc 46 and shade mesh 48 lie side by side spaced by 20 mm. The pvc weather proofs the shielded space and the mesh reduces heat gain. Each screen is operated by a crank 50 which engages an eye 52 which projects out of the head box. The hook is linked to the screen by a right angle drive 54, in this instance a worm and pinion drive. This type of drive allows the screens to be operational from inside or outside the shielded space by being accessible from the front or the back of the head box.

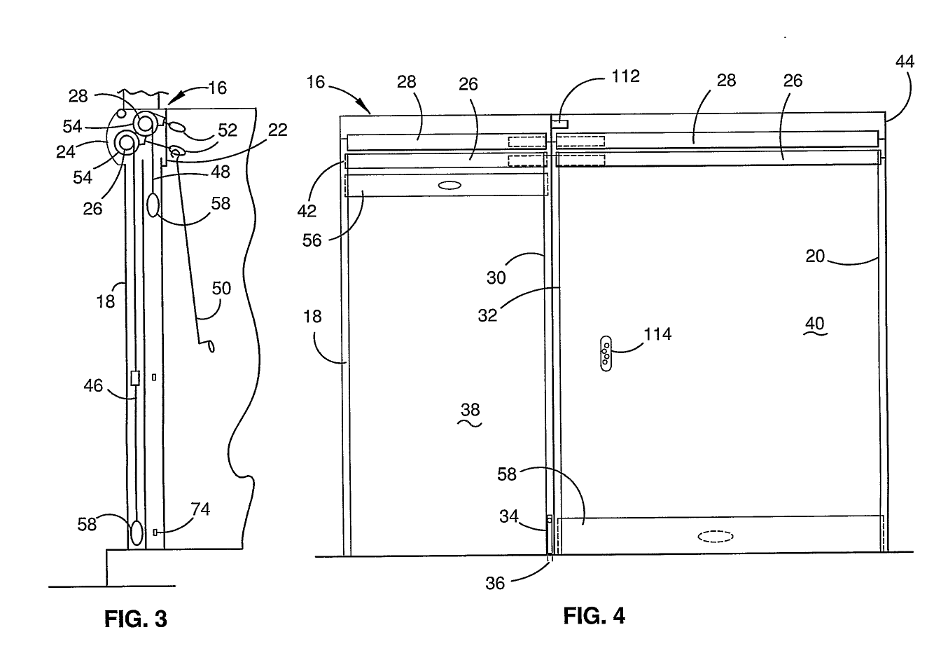

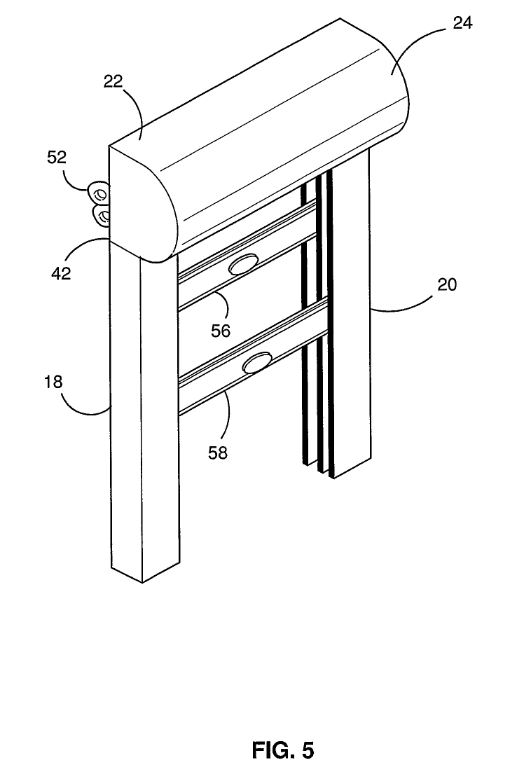

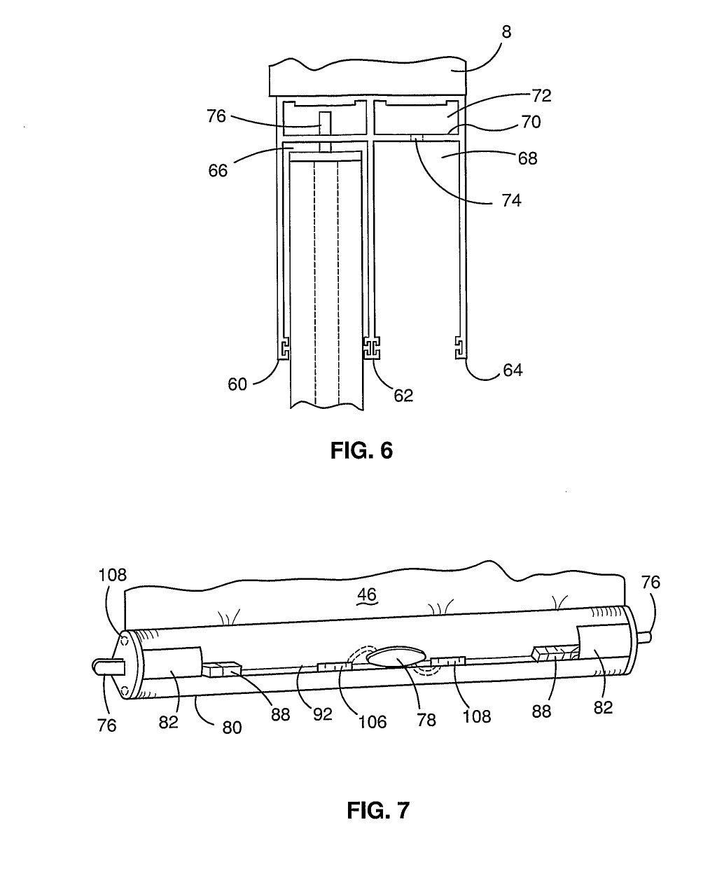

In the embodiment shown in FIGS. 2 and 3 the free end of each screen is retained by a rail 56, 58. In FIGS. 5 and 6 the rail is shown with the end thereof riding in one of the tracks of guide 30. The guide is also an aluminium extrusion having three flanges 60, 62, 64 which define the side by side tracks 66, 68. Cross wall 70 defines a bolt chamber 72 for each track. A bolt hole 74 in the cross wall receives rail bolt 76 which shoots in and out and locks the rail in the selected position. The flanges have grooves to house brush seals (not shown) in known manner. The end wall of the extrusion in use abuts the building post and is accessible for drilling through hole 74.

In FIGS. 7-9 the rail bolts 76 are operated by the handle 78 and the components shown in these figures. The rail has a hollow extruded aluminium body 80 which is cut to length to suit the job. The ends house moulded nylon bolt housings 82. The housings contain a pair of springs 84 (FIG. 9) which bias the bolt 76 to project from the end of the housing 82.

The bolt is retracted by a cruciform steel tie 86 which terminates in bolt 76. Tie 86 is joined to steel connector 88. This connector has a set of teeth 90 through which a wire 92 can be threaded.

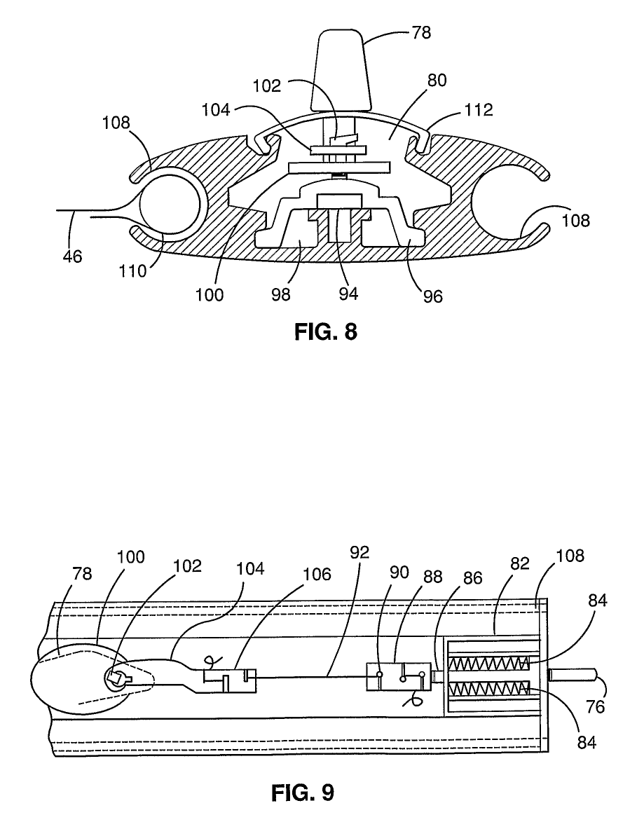

Handle 78 has a disc 94 which in FIG. 8 is shown imprisoned by cap 96 which is a snap fit in well 98 in the central axial part of the rail body 80. The handle rotates cam plate 100 from which a pair of L-shaped pins 102 project. The pins engage twin links 104. At the end of each link is a steel connector 106 resembling steel connector 88 with which it cooperates. In the installation the distance between the two connectors may vary but in practice this is not a problem because the connectors are joined by wire 92 which is threaded between the teeth of both connectors. Thus no pinch screws are required.

The rail has a top and bottom axial pocket 108 of near circular section. The end of the screen is looped and a rod 110 is inserted into the loop and the screen and rod are together fed into the pocket in known manner. The hollow rail body is closed in by snap fit cover 112.

In FIG. 4 each screen is wound on a hollow roller which accommodates a 200 w electric motor. These components are obtainable from different manufacturers, for example Imex Creative Products Pty. Ltd., Thomastown, Victoria, Australia.

We have found the advantages of the above embodiment to be:

1. The assembly occupies less space than the prior art systems and the head box can be attached through its top, back and sides.
2. The screens are operable from inside or outside the shielded space.
3. The screens are tensionable once the rail height has been selected.
4. The assembly is reducible to kit form and simplifies installation.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1. A tandem screen assembly for shielding an external area of a building comprising a head box for attachment to the outside of the building,
a first rotatable screen mountable in the head box,
a second rotatable screen mountable in front of the first screen,
a pair of upright guides mountable beneath the head box at both ends thereof arranged and aligned to provide a track for the first screen and a track for the second screen side by side.

2. A tandem screen assembly as claimed in claim 1, wherein the screens are actuatable from within the space shielded by the assembly.

3. A tandem screen assembly as claimed in claim 1, wherein the or each screen is actuatable by a crank which rotates the screen through a right angle drive coupling.

4. A tandem screen assembly as claimed in claim 1, wherein the bottom of the screen is fixed to a rail, the ends of which each ride in one track of the pair of guides.

5. A tandem screen assembly as claimed in claim 4, wherein the guides each have a bore at ground level and the ends of the rail each have a bolt and the rail has a handle for causing both bolts to engage a respective bore and retain the screen in an operative position.

6. A tandem screen assembly as claimed in claim 4, wherein the guides each have a bore at or near mid height in order to provide semi-deployment of the screen.

7. A tandem screen assembly for shielding an external area of a building comprising a head box for attachment to the outside of the building, a pair of outer upright guides mountable beneath the head box at both ends, two pairs of upright guides placed back to back intermediate the outer guides also beneath the head box thereby defining two side by side areas each protectable by two screens lying one in front of the other.

8. A tandem screen assembly as claimed in claim 7, wherein one area is narrower and intended to be a passageway to the shielded area.

9. A head box of a tandem screen assembly for shielding an external area of a building, comprising an L-section back and top for attachment to the outside of a building, a front wall and two end walls, a third wall intermediate the ends, the end walls each being adapted to mount a pair of rotatable screens and the third wall being adapted to mount the four opposite ends of both pairs of screens.

10. A bottom rail for a tandem screen assembly for shielding an external area of a building, comprising a tube, the ends of which have bolt mounts, bolts which slide in the mounts and project from the ends of the tube, a handle mount located between the ends of the tube, a rotatable handle linked to both bolts for operation in unison and a slot for receiving and retaining the free end of the screen.

11. A bottom rail as claimed in claim 10, wherein the handle is linked to both bolts by screw less connections joined by a wire tie.

12. A bottom rail as claimed in claim 10, wherein the handle rotates a cam plate and the screw less connectors are links with wire engaging teeth.

13. A bottom rail as claimed in claim 11, wherein the rail body defines an axial cavity and the handle is superimposed over the axial cavity and the handle has a disc which is imprisoned by a clamp member which is a snap fit in the cavity.

14. A bottom rail as claimed in claim 10, wherein the rail defines a pair of parallel slots for accommodating the edge of a screen each lying adjacent the longitudinal rail edge so that the rail can be inverted for installation.

15. (canceled)

16. (canceled)

17. (canceled)

18. (canceled)
